(19) United States
(12) Patent Application Publication
(10) Pub. No.: US 2010/0262377 A1
(43) Pub. Date: Oct. 14, 2010

(54) EMG AND EEG SIGNAL SEPARATION METHOD AND APPARATUS

(75) Inventor: Eric Weber Jensen, San Pol de Mar (ES)

Correspondence Address: NIXON & VANDERHYE, PC, 901 NORTH GLEBE ROAD, 11TH FLOOR, ARLINGTON, VA, 22203, US

(73) Assignee: Aircraft Medical (Barcelona) SL, Barcelona (ES)

(21) Appl. No.: 12/663,762

(22) PCT Filed: May 12, 2008
(86) PCT No.: PCT/DK2008/000176

§ 371 Date: May 17, 2010

(30) Foreign Application Priority Data
May 15, 2007 (DK) PA 2007 00732

(51) Int. Cl. G06F 19/00

(52) U.S. Cl. 702/19

(57) ABSTRACT

This invention consists of a method and apparatus for separation of the facial electromyogram (EMG) and the electroencephalogram (EEG) implemented in an index for assessing the level of consciousness during general anaesthesia. The surface EEG/EMG signal is collected from three electrodes (1) positioned middle forehead, left forehead and on the cheek, 2 cm below the middle eye line. The novelty of this method and apparatus is that the EMG is separated from the EEG to a such extent that a more reliable feature extraction of the EEG can be carried out, without significant interference from the EMG. This is necessary for example when designing an EEG based index for assessing the level of consciousness during general anaesthesia. The method could be implemented in other devices where a high quality EEG is required. The apparatus consists of electrodes and cable connected to an amplifier, a D/A-converter, a microprocessor which executes the processing and displays the result on a display. In a preferred embodiment, a combination of five or six subparameters is merged into one index, termed IDX, by a classifier. The six subparameters are the Hubert transform of the EEG (8) spectral ratios of the EEG frequencies (9-12) and the electro oculogram (EOG). The IDX is a scale from 0 to 99, where 81-99 is awake, 61-80 sedation, 41-60 general anesthesia and 0-40 deep anaesthesia.

### INTRODUCTION

The purpose of this method and apparatus is the combination of parameters extracted from a surface recording of EEG and EMG into an index where the influence of the EMG is reduced. This is conceived by a nonlinear combination of parameters from frequency and time analysis of the recorded signal.

The present invention relates to a method and apparatus for assessing the level of consciousness during general anaesthesia. For this purpose a signal is recorded from the patients scalp with surface electrodes, the recorded signal is defined as:

S=EEG+EMG+artifacts,

where the EEG is the electroencephalogram, the EMG is the facial electromyogram and the artifacts are all other signal components not derived from the EEG or EMG. The artifacts are typically 50/60 Hz hum, noise from other medical devices such as diathermy or roller pumps or movement artifacts.

However, the EMG is typically the most important source of noise which interferes with the EMG. It is difficult to separate the EEG and the EMG because they have an important spectral overlap, therefore classical filtering techniques fail to separate the EMG from the EEG. The influence is apparent, the article by Messner et al. The bispectral index declines during neuromuscular block in fully awake persons. Anesth Analg. 2003 August; 97(2):488-91 shows that a level of consciousness index is significantly changed when the EMG activity is removed by the administration of a Neuro Muscular Blocking Agent (NMBA). The level of consciousness index referred to in this article is the Bispectral Index (BIS), commercialised in the BIS monitor by Aspect Medical, Ma, USA.

The novelty of the present apparatus and method is its ability to produce an index of the level of consciousness (IDX) which is less influenced by the EMG than other existing methods. The method is the combination into a single index (IDX) of specific frequency ratios and the Hilbert transform of the recorded data. The Hilbert transform of the EEG detects discontinuities of the EEG; this algorithm is important for the separation of the EEG and the EMG.

Other methods have been examined for assessing the complexity of the EEG such as Entropy, Limpel-Zev complexity and Bispectral analysis; however the Symbolic Dynamics method is different as it explores discontinuities, characteristic of the EMG.

The IDX is a scale from 0 to 99, where 81-99 is awake, 61-80 sedation, 41-60 general anesthesia and 0-40 deep anaesthesia.

The BIS is described in U.S. Pat. Nos. 4,907,597, 5,010,891, 5,320,109; and 5,458,117. The patents describe various combinations of time-domain subparameter and frequency-domain subparameters, including a higher order spectral subparameter, to form a single index (BIS) that correlates to the clinical assessment of the patient for example carried out by the OAAS. The BIS, manufactured and commercialised by Aspect Medical Systems, has already found some clinical acceptance.

The Entropy method is described in U.S. Pat. No. 6,801,803, titled “Method and apparatus for determining the cerebral state of a patient with fast response” and commercialised by the company General Electric (GE). The Entropy is applied to generate two indices, the state entropy (SE) and the response entropy (RE). The SE is based on the entropy of the frequencies from 0 to 32 Hz of the recorded signal while the RE is based on a wider interval, i.e. from 0 to 47 Hz. Besides the Entropy, this patent includes the Lempel-Zev complexity algorithm in claims 7 as well.

The patient state analyzer (PSA) is described in U.S. Pat. No. 6,317,627. The PSA is using a number of subparameters, defined in tables 1, 2 and 3 of the patent. Included are different frequency bands such as delta, gamma, alpha and beta activity and ratios such as relative power which are merged together into an index using a discriminatory function.

The document U.S. Pat. No. 6,067,467 A(John E. R.), and the documents WO2004054441 and WO9938437 describe apparatus and methods for monitoring the level of consciousness during anaesthesia by signal processing of the EEG, however the Hilbert transformation combined with spectral parameters of the EEG as used in the present application differentiates this technique from others.

While the above approaches, BIS, Entropy, Patient State Index, are systematically and scientifically sound, there are no obvious merit or peer reviewed medical publications that suggest that they can separate the EMG from the EEG better than simple methods such as the Spectral Edge Frequency published by Gurman, “Assessment of depth of general anesthesia. Observations on processed EEG and spectral edge frequency.” Int J Clin Monit Comput. 1994 August; 11(3): 185-9.

### Introduction to Anaesthesia.

In a simplistic definition, anaesthesia is a drug induced state where the patient has lost consciousness, loss of sensation of pain, i.e. analgesia, furthermore the patient may be paralysed as well. This allows the patients to undergo surgery and other procedures without the distress and pain they would otherwise experience.

One of the objectives of modern anaesthesia is to ensure adequate level of consciousness to prevent awareness without inadvertently overloading the patients with anaesthetics which might cause increased postoperative complications. The overall incidence of intraoperative awareness with recall is about 0.2-3%, but it may be much higher in certain high risk patients, like multiple trauma, caesarean section, cardiac surgery and haemodynamically unstable patients. Intraoperative awareness is a major medico-legal liability to the anaesthesiologists and can lead to postoperative psychosomatic dysfunction in the patient, and should therefore be avoided.

A method for assessing the level of consciousness during general anaesthesia is found in the Observers Assessment of Alertness and Sedation Scale (OAAS). The OAAS is a 6 level clinical scale where the levels 3 to 5 corresponds to awake while the levels 2 to 0 indicates anaesthesia where level 0 is the deepest level, the table below shows the definition of the scale.

The OAAS scale

| Score | Responsiveness |
|---|---|
| 5 | Responds readily to name spoken in normal tone. |
| 4 | Lethargic response to name spoken in normal tone. |
| 3 | Responds only after name is called loudly or repeatedly. |
| 2 | Responds only after mild prodding or shaking. |
| 1 | Responds only after noxious stimuli. |
| 0 | No response after noxious stimuli. |

Other clinical scales exist however the disadvantage of using clinical scales in practice is that they cannot be used continously and that they are cumbersome to perform. This has lead to the investigation into automated assessment of the level of consciousness. The most prevailing method is the analysis of the EEG where a scalp EEG is recorded and subsequently processed by an algorithm which maps the EEG into an index typically in the 0-100 range.

The processing of the EEG often involves a spectral analysis of the EEG or perhaps even a simultaneous time-frequency analysis of the EEG such as the Choi-Williams distribution. The EEG can then be classified into frequency bands where delta is the lowest activity, followed theta, alpha and beta activity.

Complexity measures such as entropy and Lempel Zev complexity have been proposed as correlates to the level of consciousness.

Several parameters may then be combined into a single index by using a discriminatory function such as logistic regression, fuzzy logic, neural networks a o.

The EMG is known as influencing and superimposing the EEG rendering the interpretation of the EEG difficult due to a lower signal to noise ratio. The EMG is dominant in the frequency range from 40-300 Hz but it is present in the lower frequencies down to 10 Hz as well. This means that the EEG and the EMG cannot be separated by simple bandpass filtering. Therefore other methods should be sought in order to separate these two entities, based on the assumption that some characteristics of the two are different. The complexity of the EEG and the EMG is probably different, although both signals show highly non linear properties. The present patent includes the Hilbert Transform of the EEG in conjunction with specific frequency band ratios and a specific electrode position where a lower influence of the EMG on the final index (IDX) is achieved.

### METHODS

FIG. 1 shows the numbered steps of the method and apparatus. The first step is obtaining a signal recorded from a subjects scalp with three electrodes positioned at middle forehead (Fp), left forehead (Fp7) and above the left cheek i.e. on the zygomatic bone (1). The electrode position is important, but can be interchanged symmetrically to the right side instead of the left. The subsequent signal processing in particular the Hilbert Transform and the definition of the ratios are only correct for these particular electrode positions. The signal, S, is then amplified (2) and digitised with a sampling frequency of 1024 Hz (3). An algorithm is used to reject spurious signals which are neither EEG nor EMG. An estimation of the energy content was used for this purpose (5). As the main energy of the EEG is below 50 Hz, the signal was low-pass filtered with a 5th order Butterworth filter with cut-off frequency at 200 Hz (5). The signal is then parted into blocks of 1 s, multiplied by a Hamming window, subsequently an FFT is carried out (6).

The values of the FFT are used to calculate the Hilbert transform (8), the spectral ratios, ratio1 (9), ratio2 (10), ratio3 (11), the beta-ratio (12) and the electro oculogram (13).

Ratio1 is defined as the natural logarithm of the ratio between the energy from 24 to 40 Hz and the energy from 1 to 5 Hz of the signal.

Ratio 2 is defined as the natural logarithm of the ratio between the energy from 24 to 40 Hz and the energy from 6 to 11 Hz of the signal.

Ratio 3 is defined as the natural logarithm of the ratio between the energy from 24 to 40 Hz and the energy from 10 to 20 Hz of the signal.

The betaratio is defined as the natural logarithm of the ratio between the energy from 30 to 42 Hz and the energy from 11 to 21 Hz of the signal.

The classifier (14) defines the index of consciousness (IoC) EEG-IDX (14) and is then displayed simultaneously with the EEG and EMG (16).

### Hilbert Transform

The Hilbert Transform of an infinite continuous signal f(t) is defined as:

$$H \{ f ( t ) \} ≡ \frac{1}{π} {\int }_{- ∞}^{∞} f ( s ) \frac{1}{t - s} d s$$

The implementation of the Hilbert Transform of finite length digital signal can be calculated by means of the FFT (Fast Fourier Transform) as shown schematically below.

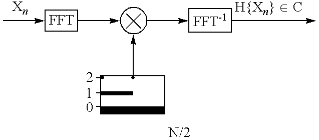

$$\begin{matrix}H \{ xn \} = {H}_{R} \{ {x}_{n} \} + {H}_{1} \{ xn \} \\ = \vert H \{ xn \} \vert \cdot {φ}_{H} \{ xn \}\end{matrix}$$

$$H \{ {X}_{n} \} = {FFT}^{- 1} ( FFT ( {X}_{n} ) * {W}_{n} )$$

$$where$$

$$Function {H}_{n}$$

$${W}_{n} = \{ \begin{matrix}2 + j 0 ; & n = 0 , n = N / 2 \\ 1 + j 0 ; & 1 \leq n \leq N / 2 - 1 \\ 0 + j 0 ; & N / 2 + 1 \leq n \leq N - 1\end{matrix} \\ where j = \sqrt{- 1}$$

The Hilbert Transformed signal gives information of the deviation of the discontinuities.

One parameter is extracted from the Hilbert transform, i.e. the number of peaks of the derivative of the Hilbert phase higher than a threshold (normalized to time length of the signal and sampling frequency)

Number peaks φ_{H}′(t)≧threshold

This threshold is defined as in the present application as approximately 3% of the maximal range in a 1 second window sampled with 1 KHz.

### Eyelash Movement

The presence of eyelash movement or slow frequency electro oculogram (EOG) is interpreted as a sign of wakefulness in the patient. The EOG is detected by the following steps
a) A one second frame of the EEG is filtered with a low pass filter at very low frequency, approximately 5 Hz.
b) A counter is increased for each sample after filtering that has a values above 3% of the maximum range, for example if a 16 bit D/A processor is used the total range is 65535, then if the energy is above circa 2000 then the counter is increased.
c) If the value of the counter, when sampling at 1000 Hz is in the range of 100 to 400, then presence of eyelash reflex is assumed.

### Classifier.

The classifier (14) applied to combine the four to six subparameters, is either a multiple logistic regression or an Adaptive Neuro Fuzzy Inference system (ANFIS) of the parameters HILBERT TRANSFORM, RATIO1, RATIO2, RATIO3, BETA-RATIO and ELECTRO OCULOGRAM.

### Multiple Logistic Regression

The output of the discriminatory function is the index derived from the EEG, termed IDX, a unitless scale from 0 to 99. This index correlates to the level of consciousness of the anaesthetised patient.

The classifier in case of a multiple logistic regression is the following:

IDX=100/(1+exp(−K1−K2*RATIO1−K3*RATIO2−K4*RATIO3−K*BETARATIO−K6*HILBERT TRANSFORM))

### Where

### −10⁶<K1<10⁶

### −4<K2<−2

### −<K3<1

### −0.1<K4<0.1

### 0<K5<0.2

### −10⁶<K6<10⁶

### ANFIS Model Structure.

The frequency ratios, RATIO1-3 and betaratio are as single parameters correlates to the depth of anaesthesia, however the correlation coefficient to the clinical signs is low. This has been shown already in numerous publications e.g. Sleigh J W, Donovan J: Comparison of bispectral index, 95% spectral edge frequency and approximate entropy of the EEG, with changes in heart rate variability during induction of general anaesthesia. Br J Anaesth 1999; 82: 666-71. However, by combining the parameters, a higher correlation coefficient can be reached. Furthermore, including the parameter of the derivative of the Hilbert transform and presence of eye-lash reflex and EOG, further refines the method.

The ANFIS is used to combine the inputs, in this application 4-6 inputs subparameters could be included. Each input is initially fuzzified into 2 or more classes, using for example Sugeno or Mamdani fuzzifier techniques. The output is defuzzified into a crisp value which is the IDX. In the present case training is needed, because ANFIS is a hybrid between a fuzzy logic model and a Neural Network. The ANFIS is then trained with data from patients where both the EEG and the level of consciousness is known. The level of consciousness is described by both the Observers Assesment of Alertness and Sedation Scale (OAAS) and the concentration of the anaesthetics, typically effect site concentration when the data derives from intravenous drugs or end-tidal concentration if the data derives from inhalatory agents. This combination of OAAS and anaesthetics concentration is transformed into a 0 to 100 scale, corresponding to the range of the IDX. In this way the training will produce a model that estimates the IDX after training.

### Performance of the Method

FIG. 2 shows a schematic example of the behaviour of the IDX and that of a classic index during administration of an anaesthetic and NMBA. In general, an index of the level of consciousness during anaesthesia should be low, typically below 70, when a patient is anaesthetised, and high when the patient is awake and conscious, typically above 85. Furthermore, the index should be independent of the presence of the facialis EMG. The level of the technology today is of a such level that certain combinations of anaesthetics, eg high dosis of opioids and low amounts of hypnotic components for cardiac anesthesia, causes a false increase in the index, as illustrated with the dashed line in FIG. 1 at the event B. When an NMBA is administered the classic index drops to the correct level <60. The novelty of the IDX is that it is less affected by the administration of the NMBA, rather it maintains the correct level althrough the maintenance of the anaesthesia, as shown in FIG. 2. This can be expressed statistically by considering the overlap of index values while awake and those while asleep. FIG. 3 shows. schematically, the Gaussean distribution of the IDX while awake and anaesthetised. The x-axis represents the IDX while the y-axis represents the probability of a certain IDX value either anaesthetised or awake. For example, the probability that the IDX is below 40 while awake is 0. The principal characteristic of the IDX is that the overlap between the two distributions, awake and anaesthetised, is low.

Two examples from recordings in the operating theatre are shown in FIG. 4 and FIG. 5. Both cases are from cardiac anaesthesia where the patient is induced with 8% sevoflurane. After the induction the anaesthesia is maintained with 0.7% sevoflurane, 0.5 ug/kg/min remifentanyl and boluses of a muscle relaxant, in this case atracurium. The case in FIG. 5 is from a case of cardiac anaesthesia, where the patient is awake i.e. OAAS=5, during the first 4.5 min of the recording. The patient is without consciousness during the rest of the recording, i.e. an OAAS <2. The IDX index maintains an average level below 70 during the whole procedure while an index which is not compensated for the influence of the EMG, shows values around 90, as if the patient were awake. The case in FIG. 5 is also from cardiac anaesthesia, here the situation is even more pronounced as the IDX is totally unaffected by the increasing amount of EMG while the classical index shows erroneously high index values for a patient with an OAAS score lower than 3. The recording in FIG. 5 was started when the patient was already anaesthetised, in this case OAAS 1.

### LEGEND TO FIGURES

FIG. 1. Flowchart of the method and apparatus.

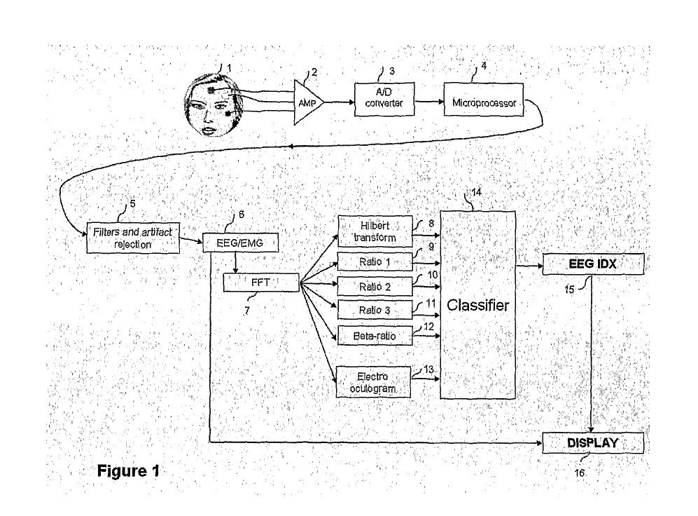

FIG. 2. Schematic example of the performance of an application of the present method.

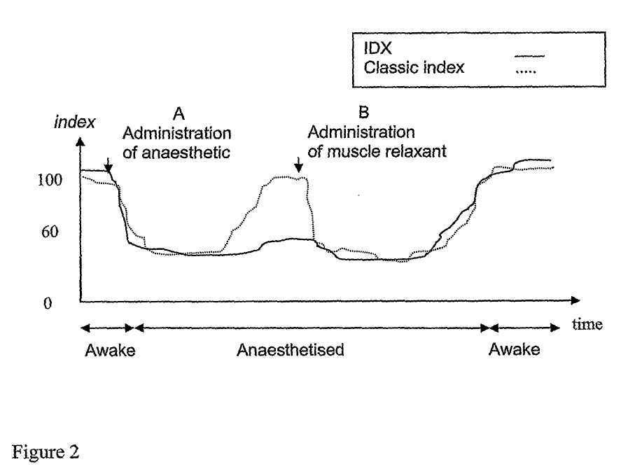

FIG. 3. Example of overlap for an index of depth of anaesthesia at awake and asleep.

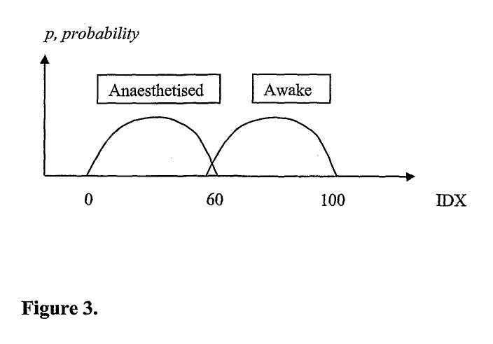

FIG. 4. Example of the performance of the new index where the EMG interference has been reduced.

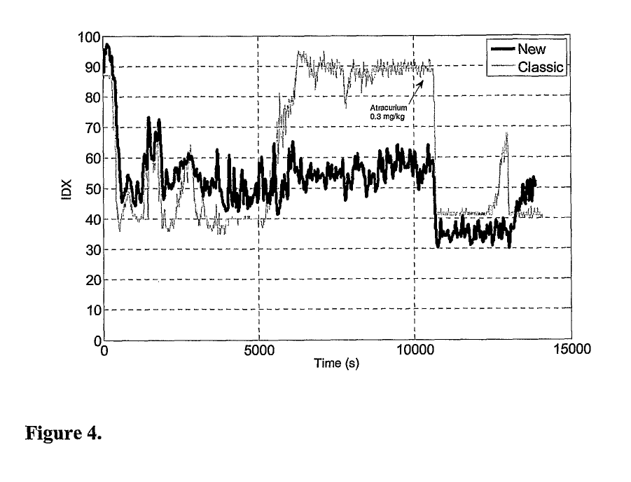

FIG. 5. Second example of the performance of the new index where the EMG interference has been reduced.

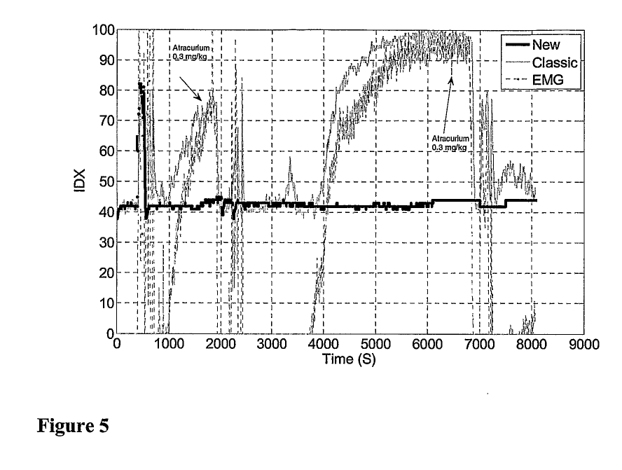

1. A method that improves the quality of the recorded electroencephalogram (EEG) by separating the electromyogram (EMG) from the recorded surface comprising the following steps:
(a) obtaining a signal recorded from a subjects scalp with three electrodes positioned at middle forehead, left (right) forehead and the left (right) cheek;
(b) amplifying with an instrumentation amplifier and digitising with an A/D converter the signal is then a sum of EEG, EMG and artifacts;
(c) calculating the Hilbert transform from approximately 1 s of the EEG signal;
(d) calculating the ratio (termed RATIO1) between the energy from 24 to 40 Hz and the energy from 1 to 5 Hz of the signal;
(e) calculating the ratio (termed RATIO2) between the energy from 24 to 40 Hz and the energy from 6 to 11 Hz of the signal;
(f) calculating the ratio (termed RATIO3) between the energy from 24 to 40 Hz and the energy from 10 to 20 Hz of the signal;
(g) calculating the betaratio (termed BETARATIO) between the energy from 24 to 40 Hz and the energy from 10 to 20 Hz of the signal;
(h) determining the presence of eye-lash reflex by lowpas filtering the signal and counting the number of samples above a limit three percent of maximum amplitude;
(i) combining the Hilbert Transform, the four ratios and the eye-lash reflex count by using a classifier into an index on a scale from 0 to 100 indicating the present EEG activity, where the majority of the EMG activity has been separated.

2. The method according to claim 1 wherein step (a) is further defined as the position of the electrodes can be either middle forehead (Fp), left
forehead (F7) and the left cheek (temporal process) 2 cm below the middle eye line or the electrode position can alternatively be middle forehead, right forehead and the right cheek (temporal process) 2 cm below the middle eye line.

3. The method according to claim 1 wherein step (c) is further refined as the number of peaks of the derivative of the Hubert phase higher than a threshold is defined as approximately 3% of the maximal range in a 1 second window sampled with 1 KHz.

4. The method according to claim 1 wherein step (d) is further defined by initially multiplying the recorded signal by a Hamming window, then calculating the Fast Fourier Transform and then calculating RATIO1 as the natural logarithm of the ratio between the energy from 24 to 40 Hz and the energy from 1 to 5 Hz of the signal; the energies are obtained by summing the values of the FFT in the defined frequency bands.

5. The method according to claim 1 wherein step (e) is further defined by initially multiplying the recorded signal by a Hamming window, then calculating the Fast Fourier Transform and then calculating RATIO2 as the natural logarithm of the ratio between the energy from 24 to 40 Hz and the energy from 6 to 10 Hz of the signal; the energies are obtained by summing the values of the FFT in the defined frequency bands.

6. The method according to claim 1 wherein step (f) is further defined by initially multiplying the recorded signal by a Hamming window, then calculating the Fast Fourier Transform and then calculating RATIO3 as the natural logarithm of the ratio between the energy from 24 to 40 Hz and the energy from 10 to 20 Hz of the signal; the energies are obtained by summing the values of the FFT in the defined frequency bands.

7. The method according to claim 1 wherein step (g) is further defined by initially multiplying the recorded signal by a Hamming window, then calculating the Fast Fourier Transform and then calculating the BETAEATIO as the natural logarithm of the ratio between the energy from 30 to 42 Hz and the energy from 11 to 21 Hz of the signal; the energies are obtained by summing the values of the FFT in the defined frequency bands.

8. The method according to claim 1 wherein step (h) is further defined by determining the presence of eye-lash reflex by lowpas filtering the signal with a cut-off frequency of 5 Hz and counting the number of samples above a limit three percent of maximum amplitude, if the number of samples above said limit is between 10 and 40% of the samples in the analysed window of approximately 1 s of duration, then eye-lash reflex is present.

9. The method according to claim 1 wherein step (i) the classifier is further defined as a multiple logistic regression or an Adaptive Neuro Fuzzy Inference System (ANFIS); combining the input parameters, wherein step (c) is further refined as the number of peaks of the derivative of the Hubert phase higher than a threshold defined as approximately 3% of the maximal range in a 1 second window sampled with 1 KHz, wherein step (d) is further defined by initially multiplying the recorded signal by a Hamming window, then calculating the Fast Fourier Transform and then calculating RATIO1 as the natural logarithm of the ratio between the energy from 24 to 40 Hz and the energy from 1 to 5 Hz of the signal; the energies are obtained by summing the values of the FFT in the defined frequency bands, wherein step (e) is further defined by initially multiplying the recorded signal by a Hamming window, then calculating the Fast Fourier Transform and then calculating RATIO2 as the natural logarithm of the ratio between the energy from 24 to 40 Hz and the energy from 6 to 10 Hz of the signal; the energies are obtained by summing the values of the FFT in the defined frequency bands, wherein step (f) is further defined by initially multiplying the recorded signal by a Hamming window, then calculating the Fast Fourier Transform and then calculating RATIO3 as the natural logarithm of the ratio between the energy from 24 to 40 Hz and the energy from 10 to 20 Hz of the signal; the energies are obtained by summing the values of the FFT in the defined frequency bands, wherein step (g) is further defined by initially multiplying the recorded signal by a Hamming window, then calculating the Fast Fourier Transform and then calculating the BETAEATIO as the natural logarithm of the ratio between the energy from 30 to 42 Hz and the energy from 11 to 21 Hz of the signal; the energies are obtained by summing the values of the FFT in the defined frequency bands and wherein step (h) is further defined by determining the presence of eye-lash reflex by lowpas filtering the signal with a cut-off frequency of 5 Hz and counting the number of samples above a limit three percent of maximum amplitude, if the number of samples above said limit is between 10 and 40% of the samples in the analysed window of approximately 1 s of duration, then eye-lash reflex is present; the output of said classifier is termed IDX, a scale from 0 to 99.

10. The method according to claim 9; in order to estimate the coefficients of the multiple logistic regression or the adaptive neuro fuzzy inference systems then a clinical scale, such as the Observers Assessment of Alertness and Sedation Scale, is transformed into a 0 to 99 scale; this scale is the output of said classifier while the derivative of the phase of the Hubert transform, RATIO1, RATIO2, RATIO3, BETARATIO and eye-lash reflex are the input; the coefficients of said classifier are estimated by a large dataset containing corresponding input-output pairs.
